(19) United States
(12) Patent Application Publication
(10) Pub. No.: US 2007/0128499 A1
(43) Pub. Date: Jun. 7, 2007

(54) CATALYST FOR FUEL CELLS

(76) Inventors: Stephen A. Campbell, Maple Ridge, BC (CA); Harmeet K. Chhina, Vancouver, BC (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/560,647

(22) Filed: Nov. 16, 2006

Related U.S. Application Data
(60) Provisional application No. 60/738,194, filed on Nov. 18, 2005.

(51) Int. Cl. B01J 23/00; H01M 4/00

(52) U.S. Cl. 429/40; 502/300; 502/325; 502/305; 502/308; 502/309

(57) ABSTRACT

A catalyst for a fuel cell comprising at least one of a metal and a non-metallic compound dispersed on a catalyst support, the catalyst support comprising at least one transition metal oxide doped with at least one trivalent transition metal, pentavalent transition metal, or hexavalent transition metal.

### CROSS-REFERENCE TO RELATED APPLICATION

This application claims the benefit under 35 U.S.C. § 119(e) of U.S. Provisional Patent Application No. 60/738,194 filed Nov. 18, 2005, which is incorporated by reference herein in its entirety.

### BACKGROUND OF THE INVENTION

1. Field of the Invention

The present invention relates to a catalyst and a fuel cell comprising the same.

2. Description of the Related Art

Electrochemical fuel cells convert fuel and oxidant into electricity. Solid polymer electrochemical fuel cells generally employ a membrane electrode assembly which includes an ion exchange membrane or solid polymer electrolyte dispersed between two electrodes typically comprising a layer of porous, electrically conductive sheet material, such as carbon fiber paper or carbon cloth. The membrane electrode assembly comprises a layer of catalyst, typically in the form of finely comminuted noble metal particles, at each membrane electrode interface to induce the desired electrochemical reaction. In operation, the electrodes are electrically coupled for conducting electrons between the electrodes through an external circuit. Typically, a number of membrane electrode assemblies are electrically coupled in series to form a fuel cell stack having a desired power output.

Most catalyst layers for solid polymer fuel cells comprise a plurality of finely dispersed noble metal particles supported on a carbonaceous support, such as carbon and graphite, due to its high electrical conductivity and relatively low cost. The noble metal particles are typically supported on a catalyst support to produce a high catalytic activity while minimizing the amount of noble metal necessary to enhance the reactions of the fuel cell. However, carbonaceous materials often oxidize during fuel cell operation, decreasing the catalytic activity of the catalyst and degrading the performance of the fuel cell.

Given these challenges, there remains a need to develop new catalysts with increased oxidation resistance. The present invention addresses these issues and provides further related advantages.

### BRIEF SUMMARY OF THE INVENTION

In one embodiment, a catalyst for a fuel cell is disclosed comprising at least one of a metal and a non-metallic compound dispersed on a catalyst support, the catalyst support comprising at least one transition metal oxide doped with at least one trivalent transition metal, pentavalent transition metal, or hexavalent transition metal.

In another embodiment, a fuel cell is disclosed comprising a catalyst, the catalyst comprising at least one of a metal and a non-metallic compound dispersed on a catalyst support, the catalyst support comprising at least one transition metal oxide doped with at least one trivalent transition metal, pentavalent transition metal, or hexavalent transition metal.

In yet another embodiment, a method is disclosed of making a catalyst for a fuel cell, the catalyst comprising at least one of a metal and a non-metallic compound dispersed on a catalyst support, the catalyst support comprising at least one transition metal oxide doped with at least one trivalent transition metal, pentavalent transition metal, or hexavalent transition metal.

These and other aspects of the invention will be evident upon reference to the following detailed description.

### DETAILED DESCRIPTION OF THE INVENTION

Unless the context requires otherwise, throughout the specification and claims which follow, the word “comprise” and variations thereof, such as “comprises” and “comprising” are to be construed in an open, inclusive sense, that is as “including but not limited to”.

In one embodiment, a catalyst for a fuel cell is disclosed comprising at least one of a metal and a non-metallic compound dispersed on a catalyst support, the catalyst support comprising at least one transition metal oxide doped with at least one trivalent transition metal, pentavalent transition metal, or hexavalent transition metal.

The metal dispersed on the catalyst support may be a noble metal, such as platinum, palladium, ruthenium, iridium, and gold, or combinations thereof, and the non-metallic compound dispersed on the catalyst support may be a chalcogenide. Alternatively, a combination of metal and non-metallic compounds may be dispersed on the catalyst support.

The catalyst support may be any semi-conducting transition metal oxide, such as titanium and zirconium, or combinations thereof. Such transition metal oxides may be doped with at least one trivalent transition metal, such as chromium; at least one pentavalent transition metal, such as niobium, tantalum, manganese, vanadium, and molybdenum; or at least one hexagonal transition metal, such as chromium and tungsten. Without being bound by theory, the dopants act as n-type donor or p-type acceptor ions, depending on the valency of the dopant transition metal, thereby enhancing the electrical conductivity of the transition metal oxide. The transition metal oxide should be doped in an amount sufficient to enhance its electrical conductivity at low temperatures, for example, less than 200° C. The electrical resistivity of the doped transition metal oxide may range from 10⁻⁶ to 10³ ohm-cm, for example, from 10⁻⁶ to 1 ohm-cm. Dopant levels may be, for example, between about 10¹⁹ and 10²² atoms/cm³.

The surface area of the catalyst support may range from about 30 or about 100 to about 1500 m²/g. The average particle size of the catalyst support may be at least one magnitude of order greater than the average particle size of the at least one of a metal and a non-metallic compound. For example, if the average particle size of the at least one of a metal and a non-metallic compound is 10 nm, then the average particle size of the catalyst support is at least 100 nm. In general, the particle size of the catalyst support may range from about 30 nm to about 2 μm.

In another embodiment, a fuel cell comprises a catalyst, the catalyst comprising at least one of a metal and a non-metallic compound dispersed on a catalyst support, the catalyst support comprising at least one transition metal oxide doped with at least one trivalent transition metal, pentavalent transition metal, or hexavalent transition metal.

In yet another embodiment, a method of making a catalyst is disclosed for a fuel cell, the catalyst comprising at least one of a metal and a non-metallic compound dispersed on a catalyst support, the catalyst support comprising at least one transition metal oxide doped with at least one trivalent transition metal, pentavalent transition metal, or hexavalent transition metal. In one embodiment, the catalyst support is prepared via a sol-gel method. The at least one of a metal and non-metallic compound is then deposited onto the surface of the catalyst support by any method known in the art, such as those described in PCT Publication No. WO 94/24710 and U.S. Pat. No. 5,068,161, to form the catalyst.

All of the above U.S. patents, U.S. patent application publications, U.S. patent applications, foreign patents, foreign patent applications and non-patent publications referred to in this specification and/or listed in the Application Data Sheet, are incorporated herein by reference, in their entirety.

While particular elements, embodiments, and applications of the present invention have been shown and described, it will be understood that the invention is not limited thereto since modifications may be made by those skilled in the art without departing from the spirit and scope of the present disclosure, particularly in light of the foregoing teachings.

What is claimed is:

1. A catalyst for a fuel cell comprising at least one of a metal and a non-metallic compound dispersed on a catalyst support, the catalyst support comprising at least one transition metal oxide doped with at least one trivalent transition metal, pentavalent transition metal, or hexavalent transition metal.

2. The catalyst of claim 1 wherein the metal comprises a noble metal, or alloys thereof, or mixtures thereof.

3. The catalyst of claim 2 wherein the noble metal is selected from the group consisting of platinum, palladium, ruthenium, iridium, and gold.

4. The catalyst of claim 1 wherein the non-metallic compound comprises a chalcogenide.

5. The catalyst of claim 1 wherein the catalyst support is at least one oxide of titanium and zirconium.

6. The catalyst of claim 1 wherein the at least one transition metal oxide is doped with at least one trivalent transition metal, pentavalent transition metal, or hexavalent transition metal, at a level between about 10¹⁹ and 10²² atoms/cm³.

7. The catalyst of claim 1 wherein the at least one trivalent transition metal is chromium.

8. The catalyst of claim 1 wherein the at least one pentavalent transition metal is selected from the group consisting of niobium, tantalum, manganese, vanadium, and molybdenum.

9. The catalyst of claim 1 wherein the at least one hexavalent transition metal is chromium or tungsten.

10. The catalyst of claim 1 wherein the surface area of the catalyst support is at least about 30 m²/g.

11. The catalyst of claim 1 wherein the surface area of the catalyst support is at least about 100 m²/g.

12. The catalyst of claim 1 wherein the particle size is of the catalyst support material is at least one magnitude of order greater than the at least one of a metal and a non-metallic compound.

13. The catalyst of claim 1 wherein the catalyst support has an electrical resistivity in the range of 10⁻⁶ to 10³ ohm-cm.

14. The catalyst of claim 1 wherein the catalyst support has an electrical resistivity in the range of 10⁻⁶ to 1 ohm-cm.

15. A fuel cell comprising a catalyst, the catalyst comprising at least one of a metal and a non-metallic compound dispersed on a catalyst support, the catalyst support comprising at least one transition metal oxide doped with at least one trivalent transition metal, pentavalent transition metal, or hexavalent transition metal.

16. The fuel cell of claim 15 wherein the catalyst support is at least one oxide of titanium and zirconium.

17. The fuel cell of claim 15 wherein the at least one transition metal oxide is doped with at least one trivalent transition metal, pentavalent transition metal, or hexavalent transition metal, at a level between about 10¹⁹ and 10²² atoms/cm³.

18. The fuel cell of claim 15 wherein the at least one trivalent transition metal is chromium.

19. The fuel cell of claim 15 wherein the at least one pentavalent transition metal is selected from the group consisting of niobium, tantalum, manganese, vanadium, and molybdenum.

20. The fuel cell of claim 15 wherein the at least one hexavalent transition metal is chromium or tungsten.
